(19) United States
(12) Patent Application Publication
(10) Pub. No.: US 2002/0194337 A1
(43) Pub. Date: Dec. 19, 2002

(54) System and method for controlling access to data stored in a portable storage medium

(76) Inventors: Tony D. Knight, Moraga, CA (US); Adam Zell, Moraga, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/209,091

(22) Filed: Jul. 30, 2002

Related U.S. Application Data
(63) Continuation of application No. 09/372,482, filed on Aug. 11, 1999, now abandoned.

(51) Int. Cl. G06F 15/16

(52) U.S. Cl. 709/225; 709/229; 711/163

(57) ABSTRACT

A method and system for controlling access to a data object stored on a portable storage medium. A request to access a data object stored on the portable storage medium is received. A first attribute associated with the data object is inspected to determine if read access to the data object is permitted. An access control portion of a file stored on the portable storage medium is inspected to determine an offset within the file at which the data object is stored. If the first attribute indicates that read access to the data object is permitted, then the data object is read at the offset within the file.

### FIELD OF THE INVENTION

The present invention relates to the field of information storage and delivery, and more particularly to a method and system for controlling access to data stored in a portable storage medium.

### BACKGROUND OF THE INVENTION

In the summer of 1991 executives at Apple Computer, Inc. made two important decisions that changed the face of computing as we know it today. First, they decided to bundle a double speed CD-ROM drive with every desktop machine they sold. CD-ROM drives had been around since the late 1980's, but their installed base was so low on both the Macintosh and the IBM clone platform, that very few software manufacturers were using it as a means of distributing their products. The only way to drive market share, Apple thought, was to make the drive standard across all their product offerings. Their reasons for wanting to increase the installed base of CD-ROMs was tied to their second big decision, the release of QuickTime, Apple's software for the playback of video, sound, and other time based, media-rich content. Over the next two years, every major computer hardware manufacturer followed Apple's lead, and the multimedia industry was born. Soon, the inclusion of video, sound, graphics, and text became an expected aspect of the computing experience.

Later that year, the first computer code of the World Wide Web was posted in a newsgroup called alt.hypertext, and a new standard for publishing documents containing graphics, text and sound over the Internet emerged. A group of student programmers at the University of Illinois used this new standard, called hypertext markup language (HTML), to develop the first graphical browser for the World Wide Web. Back then it was called Mosaic, but it was the basis for today's web browsers. Soon the Internet, once used solely by academics and military contractors, became a source of information, entertainment, and commerce for a growing group of consumers.

In late 1995, key leaders in the entertainment industry teamed up to create the standard for the Digital Versatile Disk, and DVD, as it would become to be known, was born. DVD was designed to provide theatre-quality video and sound, but it was also a vast data storage device, holding as much as 18 gigabytes on a single disk. In mid-1997, the first consumer DVD-video disk hit store shelves, and the drive to replace the aging VHS playback standard was on.

These three separate technological innovations have changed the way we consume information. Each standard has its own unique characteristics that dictate its application. CD-ROM and DVD disks are fast portable storage containers that can be mass produced, and the information on them can be retrieved very quickly. The drawback of both these technologies is that once the disks are replicated, the information held within is static and cannot be updated. The Internet, however does not have this problem. It is a much vaster container of digital information which can be updated quickly and easily. The major drawback of the Internet is that it is neither portable, nor can its data be accessed at the same high speeds as either CD-ROM or DVD. The amount of information an Internet user can consume is limited by the bandwidth of their Internet connection, which for most people is 56 kilobits per second or less; a paltry amount when compared to DVD. Content providers could use one technology or another, but not both together in a seamless fashion. Until now, there has not been an adequate interface for leveraging the strengths of these technology platforms while minimizing their weaknesses.

### SUMMARY OF THE INVENTION

A method and system for controlling access to a data object stored on a portable storage medium is disclosed. A request to access a data object stored on the portable storage medium is received. A first attribute associated with the data object is inspected to determine if read access to the data object is permitted. An access control portion of a file stored on the portable storage medium is inspected to determine an offset within the file at which the data object is stored. If the first attribute indicates that read access to the data object is permitted, then the data object is read at the offset within the file.

Other features and advantages of the invention will be apparent from the accompanying drawings and from the following detailed description.

### BRIEF DESCRIPTION OF THE DRAWINGS

The present invention is illustrated by way of example and not limitation in the figures of the accompanying drawings in which like references indicate similar elements and in which:

FIG. 1 is a high level diagram illustrating application of the above-described UTP handler and virtual file system driver according to one embodiment;

FIG. 2 illustrates an exemplary web page that includes an HTTP link to information on a server computer and a UTP link to information on a portable storage medium that has been inserted into a media reader of the computer used to display the web page;

FIG. 3 illustrates a flow diagram of the UTP handler according to one embodiment;

FIG. 4 is a flow diagram of a virtual file system driver according to one embodiment;

FIG. 5 illustrates the content of the access control block of a packed file and a corresponding access control table according to one embodiment; and

FIG. 6 illustrates an exemplary application of a combination of the virtual file system and the UTP handler.

### DETAILED DESCRIPTION

A method and system for seamlessly presenting information from remote and local sources to a user and for allowing remote control of access to the local source of information are disclosed. A specialized network protocol referred to herein as the Universal Transfer Protocol (UTP) is provided to manage access to a local storage media in response to user activation of hypertext links in HyperText Markup Language (HTML) pages that have the UTP prefix. For example, when viewing an HTML page using a World Wide Web browsing application (a “web browser”), a user may activate any number of hypertext links, each referring to a URL. URLs that include HyperText Transfer Protocol (HTTP) prefixes are handled by a protocol handler that seeks an HTML page from a remote server indicated by the URL. URLs that include UTP prefixes are handled by a UTP handler that is provided as a dynamic link library (DLL) to the web browsing application used to activate the link. The UTP handler processes the URL to access information on a local storage media. Depending on the nature of the UTP link, the UTP handler may return the information for display by the browser or a plug-in of the browser, or the UTP handler may invoke a separate application to present the information. In either case, the experience of the end-user is that by using the browser and activating hypertext links in HTML pages, information is presented transparently and seamlessly from both local or remote sources. Except for an occasional flash of a disk drive light (or other media reading device), the user is not informed and need not know the source of the information being presented.

Because local storage media such as DVD and CD-ROM represent a much higher bandwidth conduit for information delivery than the Internet connections of most computer users, bandwidth intensive information, such full-spectrum audio, video, or other media-rich content, which would otherwise be noticeably impacted by delivery over a voice-frequency Internet connection may instead be delivered in real-time from local media in response to activation of UTP links.

In one embodiment, access to information stored on local storage media is controlled by packing the individual data objects comprised by the information into a specialized file, called a packed file, that includes access control information specifying a URL, name, length and attribute set for each data object in the file. A dedicated file system device driver is provided to interact with the packed file. Because the packed file and the file system driver effectively constitute an additional file system layer that resides on top of the existing file system structure maintained by the computer's operating system and standard file system driver, the packed file and file system driver are referred to herein as a “virtual file system” and the file system driver as the “virtual file system driver.”

By combining the UTP protocol with the virtual file system, numerous opportunities to extend the relationship between information providers and consumers are created. For example, a DVD having a movie stored thereon may also include a packed file with numerous other content, such as games, quizzes, sound-tracks, still images, another movie and so forth. The user may be notified that the additional content is available (e.g., during movie playback on a DVD player) and prompted to install the DVD into a DVD-ROM drive of a computer. As discussed below, an installation program located on the DVD-ROM may be used to load the virtual file system driver and UTP handler into the user's computer and to initiate communication with a server computer system used to host the DVD-ROM provider's website via the user's web browser. The server computer may then transmit web pages for presentation by the user's web browser, including pages that describe additional content available to the user. The user may be given free access to the additional content, or the user may be required to supply information, money or other consideration for access to the content. Based on the user's input, web pages may be provided with appropriate UTP links for enabling access to all or a selected portion of the data objects provided in the virtual file system. Thus, a direct and potentially ongoing relationship may be established between the DVD-ROM provider and the end consumer. As discussed below, numerous variations of the above interaction are possible using embodiments of the present invention.

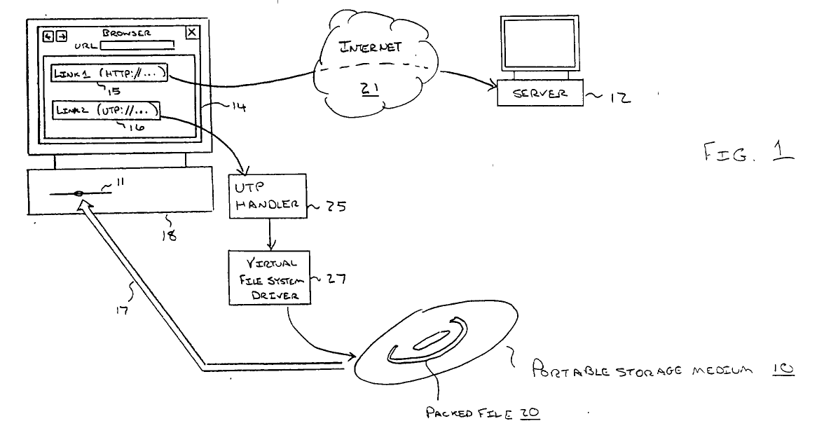

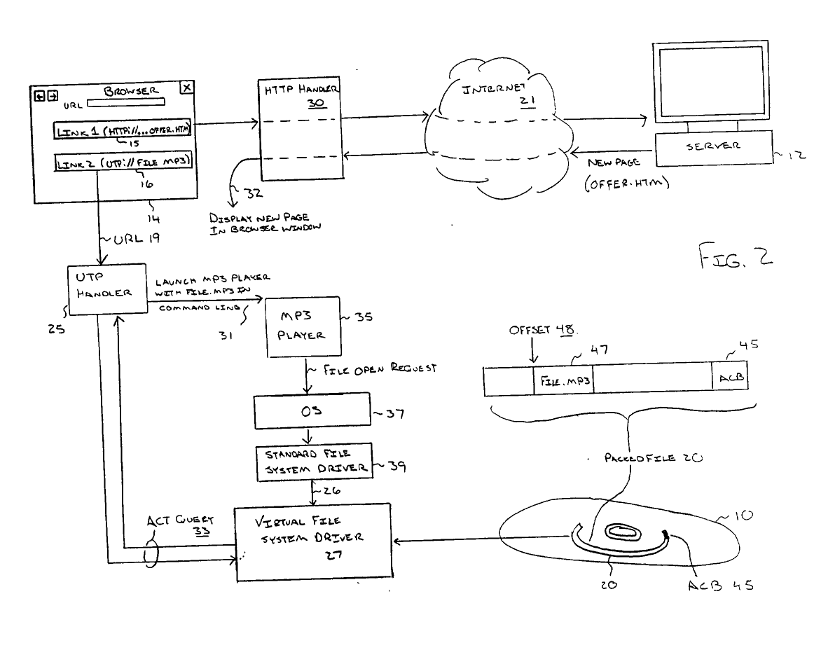

FIG. 1 is a high level diagram illustrating application of the above-described UTP handler 25 and virtual file system driver 27 according to one embodiment. A computer user initially installs a DVD, CD-ROM, magnetic storage disk or any other portable storage medium 10 in an appropriate media reader 11 of his or her computer 18 as indicated by arrow 17. As discussed below, the portable storage medium 10 preferably includes an installation program that is automatically loaded into the system memory of the computer 18 and executed by a processing unit within the computer 18 to install the virtual file system driver 27 and the UTP handler 25 into the user's computer 18. In a preferred embodiment, a startup application program is also loaded into the user's computer 18 and executed.

In one embodiment, the startup application program welcomes the user and prompts the user to connect to the website of a content provider (i.e., the provider of the content on the portable storage medium), for example, by clicking a “Begin” button presented on the computer's display. If the user clicks the Begin button, a web browsing application program is invoked and passed a URL (e.g., in the command line used to invoke the web browser) that causes a web page of the content provider's website to be displayed in the browser window 14. In an alternate embodiment, the startup application may immediately invoke the web browsing application and pass the URL to cause the content provider's web page to be displayed. In either case, the user is presented with a page from the content provider indicating that additional content or information is available to the user. As discussed below, the user is preferably required to provide some consideration (e.g., money or information) in return for access to the additional content, but at some point is presented with a web page that identifies one or more additional items of content available to the user. Note that the user need not be informed that the additional items of content are located on the portable storage medium 10, nor need the user be informed of all the items of content stored on the portable storage medium 10. To the contrary, the source of the content (local or remote) is preferably not made known to the user so that the user's overall experience is that of using the web browser to view information without knowledge of its source. Further, it is contemplated that the content of the portable storage medium 10 may be released in a time-based manner so that the user receives incentive to visit the content provider's website on future occasions. For example, the content provider's website may indicate that a particular game, movie, sound-track, etc. is available when the user accesses the website, but that, at a later date, a different game, movie or sound-track will be made available. Both items of content, i.e., the subjects of the present and future offers, may be present on the portable storage medium 10, but that fact need not be disclosed to the user.

Assuming that the user has performed the actions necessary to entitle him or her to access additional content, a web page is presented in the user's browser window 14 that may include a number of links 15, 16 to other information. For example, Link1 (15) is a HTTP link that, when selected, causes a URL to be transmitted to the server computer system 12 used to host the content provider's website. Thus, the server computer system 12 may return an HTML page containing additional links. By contrast, Link2 (16) is a UTP link to the indicated content. When the user clicks the UTP link 16, the URL specified by the link is passed to the UTP handler 25 by the browser. The UTP handler 25 may undertake a number of different actions, depending on the URL, but generally will query the virtual file system driver 27 to confirm the presence and readability of an item of content in a packed file 20 on the portable storage medium 10.

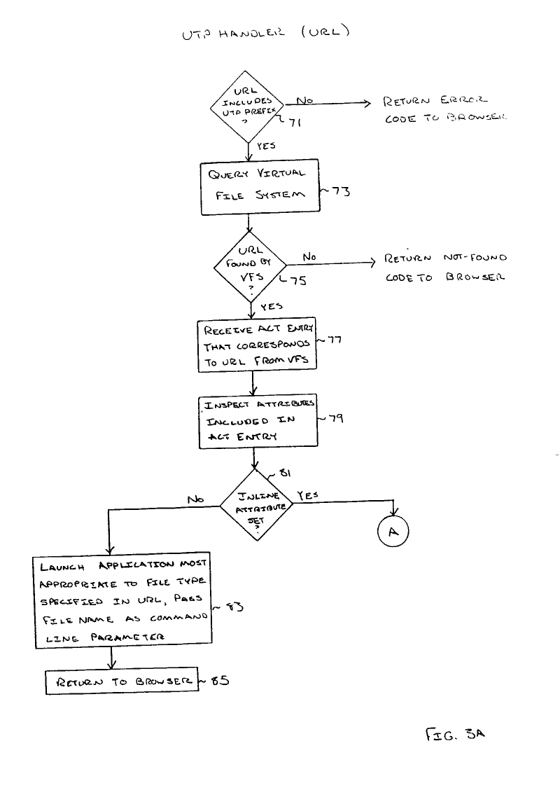

FIG. 2 illustrates an exemplary web page displayed in browser window 14 that includes an HTTP link 15 (LINK1) to information on a server computer and a UTP link 16 (LINK2) to information on a portable storage medium 10. As shown, the HTTP link 15 corresponds to an HTTP URL “HTTP://..../OFFER.HTM,” while the UTP link 16 corresponds to a UTP URL “UTP://SOUND1.MP3.” From the user's perspective, however, both links simply lead to more information, whether in the form of additional HTML pages, audio playback, video playback, or other applications. Thus, if the user clicks the HTTP link 15, the corresponding URL is received by an HTTP protocol handler 30 included within the browser code which, when executed, transmits the URL to the server computer 12 used to host the content provider's website via the Internet 21. The server computer 12 responds by transmitting a web page (OFFER.HTM) back to the user's computer where it is displayed in the browser window 14. This is indicated in FIG. 2 by arrow 32.

If the user clicks the UTP link 16, a UTP handler 25 processes the corresponding URL 19 according to a set of rules embodied in the UTP handler program code. In one embodiment, for example, the UTP handler 25 first confirms the presence and readability of a data object indicated by the UTP link 16 by querying an access control table (ACT) maintained by the virtual file system driver 27. This is indicated by arrows 33. As discussed below, the ACT is initially copied from an access control block 45 stored within a packed file 20 on the portable storage media 10. The access control block 45 is preferably encrypted to prevent unauthorized access. The content of the ACT and access control block 45 are discussed in below in greater detail.

After the UTP handler 25 has confirmed the presence and readability of the data object specified by the URL 19, the UTP handler 25 may take a number of different actions based on attributes obtained from an ACT entry that corresponds to the URL 19. For example, the UTP handler 25 may communicate with a remote server (e.g., server 12) to determine whether the remote server has a newer version of the data object specified by the URL 19, the UTP handler 25 may execute a library function specified by the URL 19, the UTP handler 25 may launch an application program indicated by a data file specified in the URL 19, the UTP handler 25 may return data to the web browser for presentation in the browser window 14 or in a window generated by a plug-in module of the browser, and so forth.

In the example of FIG. 2, the filename extension “MP3” in the filename “FILE.MP3” informs the UTP handler 25 that an application program for playing MP3-formatted files may be invoked to process the file. Thus, the UTP handler 25 invokes an MP3 playback application program 35, specifying the filename “FILE.MP3” in the command line. When invoked, MP3 playback application 35 issues a file open request to the operating system 37 requesting read access to the FILE.MP3 file. The operating system passes the file open request to a standard file system driver 39 which, in turn, passes the request through a queue of device drivers that includes the virtual file system driver 27. The virtual file system driver 27 responds to the file open request (indicated by arrow 26) by inspecting the ACT to confirm presence and readability of the FILE.MP3 file within the packed file 20 and then returns a file descriptor that can be used by the MP3 playback application 35 in subsequent file read operations. Thereafter, file read requests may be issued by the MP3 playback application 35 and handled by the virtual file system driver 27 to access the FILE.MP3 file at the appropriate offset 48 within the packed file 20 to generate a stream of audio data to the MP3 playback application 35.

Still referring to FIG. 2, it should be noted that the user of web browser does not need to know whether the links 15, 16 in the web page are used to access data locally or remotely. From the user's perspective, he or she clicks one link (the HTTP link) to receive a new web page and clicks the other link to hear an audio recording—all as part of the “web browsing” experience. From an operational standpoint, however, media-rich content (e.g., audio, video, etc.) is presented in real-time to the user, without the usual delays associated with receiving content over the Internet.

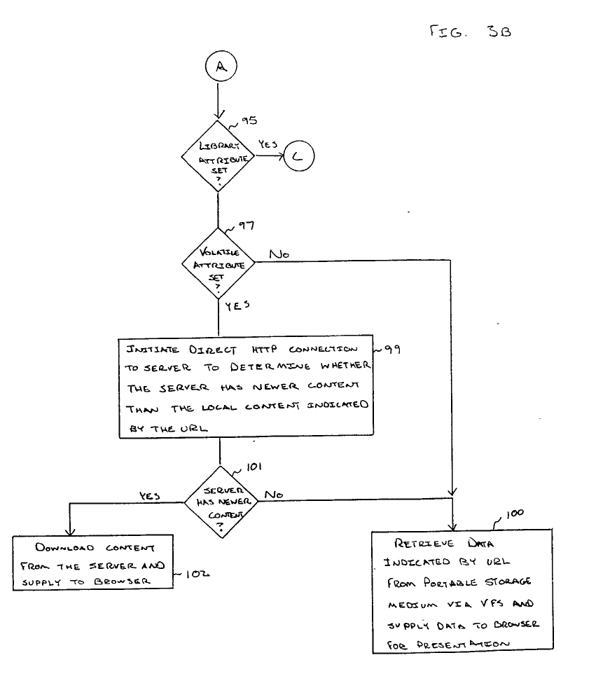

FIGS. 3A, 3B and 3C illustrate operation of the UTP handler 25 according to one embodiment. As discussed above, the UTP handler 25 is invoked by the web browser when a URL containing the UTP prefix is encountered and receives the URL as a passed parameter. At decision block 71, an incoming URL is inspected to ensure that it specifies the UTP protocol. If not, the handler is exited, returning an error code to the web browser. If the URL does specify the UTP protocol, then the UTP handler 25 queries the virtual file system at block 73 to determine whether the URL corresponds to a data object within the packed file. As discussed below, the virtual file system driver 27 responds to the query request by determining whether the ACT contains the query URL. If, at decision block 75, the virtual file system indicates that the URL is not present in the ACT, then the UTP handler 25 returns a code to the web browser indicating that the data object was not found.

If the virtual file system driver 27 indicates that the URL is present in the ACT, then an entry of the ACT containing the URL, or at least a set of attributes specified in the entry, is received from the virtual file system driver 27 at block 77. At block 79, the set of attributes in the access control table entry are inspected. If, at decision block 81, an “Inline” attribute is determined to be set, then execution proceeds to decision block 95 in FIG. 3B. If the Inline attribute is not set, then at block 83, an application program appropriate to the file type specified by a filename in the argument portion of the URL is launched and the filename is passed to the application as a command line parameter. The application program may be, for example, a movie playback application, an audio playback application, an image editing application or any other application program useful for presenting data obtained from the packed file 20. The UTP handler 25 then returns to the browser.

Referring now to FIG. 3B, a “Library” attribute is inspected at decision block 95 to determine whether a library function is to be executed in response to the incoming URL. If so, then the UTP handler 25 proceeds to block 111 of FIG. 3C. If the Library attribute is not set, then at decision block 97, a “Volatile” attribute is inspected. If the Volatile attribute is set, then at block 99 a server computer indicated by the URL is accessed via a HTTP transmission to determine whether the server computer has newer content than the local content indicated by the URL. If, at decision block 101, the server computer is determined to have newer content, the content is downloaded from the server and supplied to the browser at block 102. If the server does not have newer content, the data object indicated by the URL is retrieved from a packed file on the portable storage medium via the virtual file system driver 27 and supplied to the browser at block 100.

Referring now to FIG. 3C, block 111 is reached in response to detecting that the Library attribute is set in the access control table entry that corresponds to an incoming URL. A function within the library is identified based on the URL at block 113 and called at block 115. If the function is to provide data to the UTP handler 25 (decision block 117), then the data is passed to the UTP handler 25 via a call back interface in the UTP handler 25 at block 119. At decision block 121, a value returned by the function is inspected to determine whether an error occurred during function execution. If so, an appropriate error code is returned to the browser at block 125. If an error has not occurred, then at block 123 any data supplied to the UTP handler 25 in block 119 is supplied to the browser via a call back interface in the browser. Also at block 123, the address space in the UTP handler 25 that was allocated to the library code in block 111 is freed.

It should be noted that the order of evaluation of the various attributes (e.g., decision blocks 81, 95, 97) may be different in alternate embodiments. For example, the volatile attribute may be evaluated first so that, regardless of whether a library function is to be executed or whether the content indicated by the URL is to be presented in the web browser or another application, the source of the content (local or remote) is made first.

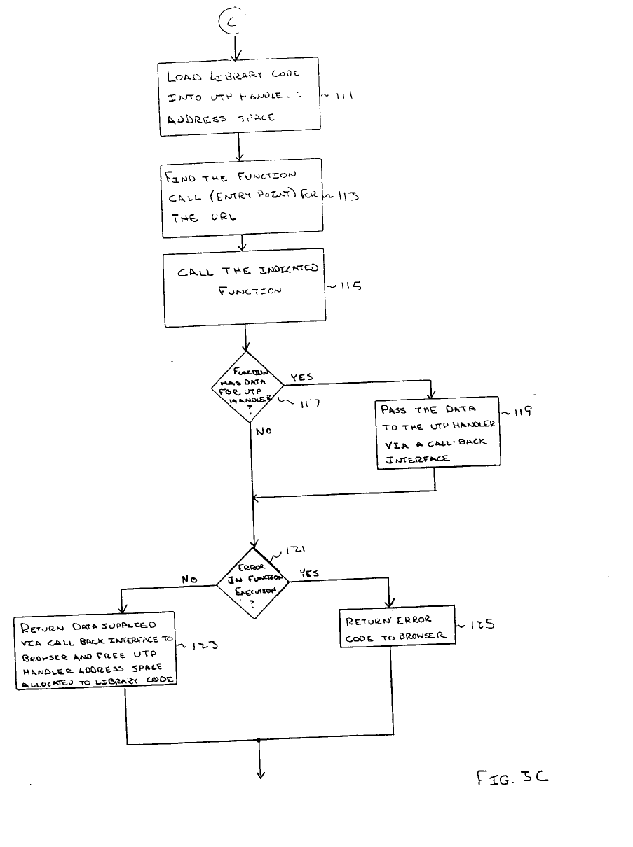

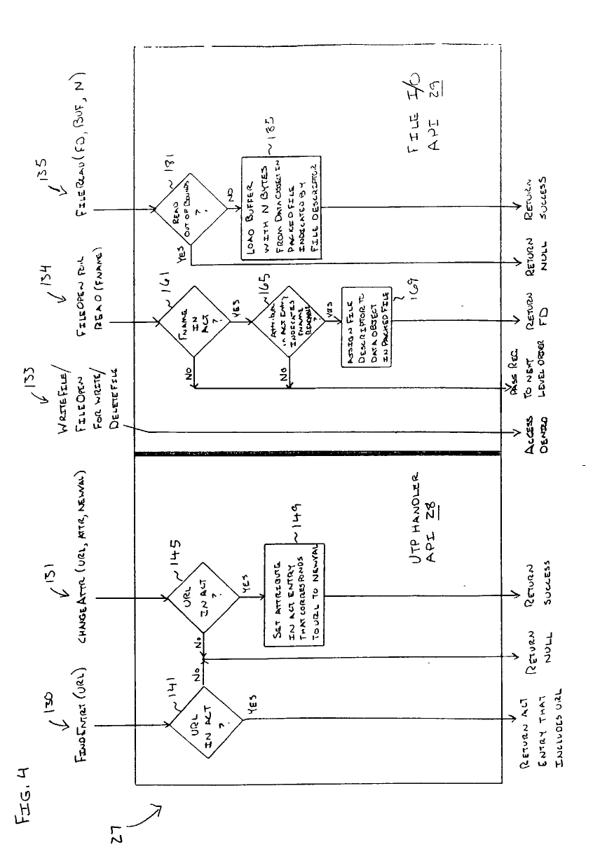

FIG. 4 illustrates a virtual file system driver 27 according to one embodiment. In one embodiment, the virtual file system driver 27 includes two application programming interfaces (APIs): an UTP handler API 28 to support direct calls from the UTP handler 25 and an file input/output (I/O) API 29 to support file I/O requests that are passed down from the standard file system driver. The UTP handler API 28 includes a FindEntry routine 130 to find an entry in the ACT maintained by the virtual file system driver 27 as well as a ChangeAttr routine 131 to change an attribute associated with a data object in a packed file. The UTP handler API 28 may also include any number of other routines for inspecting or modifying the ACT. The File I/O API 29 includes routines for supporting file open and file access requests.

Referring to the UTP handler API 28, the FindEntry routine 130 receives a URL as an incoming parameter. At decision block 141, the FindEntry routine 130 inspects the ACT to determine whether there is an ACT entry that contains a matching URL. If so, the ACT entry containing the matching URL is returned to the UTP handler 25. Note that this may be accomplished by returning a pointer to a text string, a pointer to a data structure representative of the ACT entry, the actual data from the entry, or any other technique for returning data to a caller. If no matching entry is found in the URL, a null value is returned to the UTP handler 25.

In one embodiment, the ChangeAttr routine 131 receives as incoming parameters a URL, an attribute specifier (ATTR) and a new attribute value (NEWVAL). If, at decision block 145, an entry of the ACT is determined to contain the incoming URL, then at block 149 the attribute in the ACT entry specified by ATTR is set to NEWVAL. A success code is then returned to the UTP handler 25. If the ACT does not have an entry containing the incoming URL, then a null value is returned to the UTP handler 25.

Routines that support the file I/O API 29 of the virtual file system driver 27 include routines for opening a file and routines for accessing the file. Because the portable storage medium containing the packed file is typically a read-only medium, the virtual file system driver 27 will intercept requests to write or modify data and return an error value to the caller indicating that access is denied. This is indicated by arrow 133. In an alternate embodiment, the file system driver may include support for file write and delete operations in order to support such operations on writeable media.

A request to open a file for read access 134 is preferably accompanied by a filename (FNAME). At decision block 161, the virtual file system driver 27 inspects the ACT to determine whether the incoming filename is recorded in an ACT entry. If not, the request is passed on to the next level driver. If the filename is recorded in an ACT entry, then an “IsReadable” attribute in the ACT entry is inspected at decision block 165 to determine whether read access to the corresponding data object in the packed file is permitted. If read access is not permitted, then the request is passed on to the next level driver. If read access to the data object is permitted, then at block 169 a file descriptor is assigned to the data object. The file descriptor (FD) is then returned to the higher level device driver in the chain of file system drivers and ultimately to the file open requestor.

A request to read data from an open file 135 preferably includes a file descriptor (FD), a buffer pointer (BUF) and a value (N) indicating the number of bytes to be read. The read request is evaluated at decision block 181 to determine if it will result in reading past the end of the data object in the packed file (i.e., an out of bounds read). This may be accomplished, for example, by comparing the sum of N and a current file pointer against the size of the data object. If the read request will result in an out of bounds read, a null value (or error code) is returned to the caller. Otherwise, at block 185, the buffer pointed to by BUF is loaded with N bytes from the packed file data object indicated by the file descriptor. A success code is then returned to the caller.

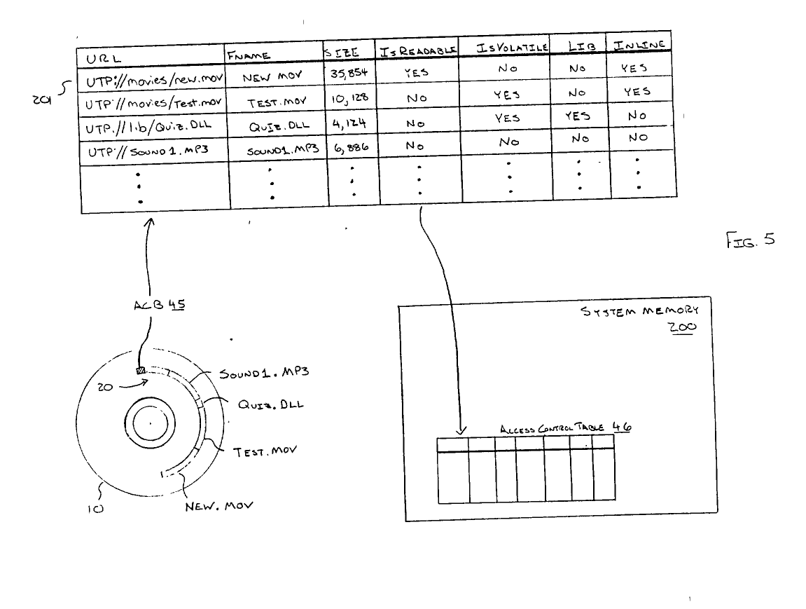

FIG. 5 illustrates the content of the access control block 45 of a packed file 20 and a corresponding access control table according to one embodiment. As shown, the packed file 20 is preferably arranged in a contiguous region of storage on a portable storage medium 10. In alternate embodiment, however, the packed file 20 may be distributed in fragmentary storage areas on the portable storage medium 10 or even across multiple portable storage media or fixed storage media, such as hard disk drives. The access control block 45 is preferably encrypted to prevent easy determination of the offsets of the data objects stored in the packed file. The virtual file system driver 27 may include the key necessary for decrypting the content of the access control block 45, or the key may be maintained remotely (e.g., on a web server) and provided only when appropriate consideration (e.g., payment, information, etc.) is supplied by a computer user.

The exemplary packed file of FIG. 5 includes four data objects (new.mov, test.mov,quiz.dll, and sound1.mp3) that are themselves files. Herein, the term file is used broadly to mean any quantity of data having an identifiable beginning and end. In one embodiment, each entry 201 in the access control block 45 includes a URL, filename, size, and set of attributes for a given data object in the packed file 10. The set of attributes preferably includes an “IsReadable” attribute to indicate whether the data object may be read, an “IsVolatile” attribute to indicate whether an alternate version of the data object may be available, a “Lib” attribute to indicate whether the data object is a library of executable code, and an “Inline” attribute indicating whether the data object is to be processed in the browser or in a separate application program.

By the above arrangement, the access control block 45 indirectly indicates the offset of each data object in the packed file, because the starting location of each data object is located immediately after the ending location of the previously listed data object. Thus, as shown in FIG. 5, the offset of test.mov is the size of new.mov, the size of new.mov being specified in the access control block 45. Similarly, the offset of quiz.dll is the size of new.mov plus the size of test.mov, and so forth. In an alternate embodiment, starting offsets for the individual data objects may be specified directly in the access control block 45 either in an absolute or relative format.

As discussed above, the content of the access control block 45 is preferably copied to an access control table (ACT) 46 in system memory 200, for example, at the initial installation of the virtual file system driver 27. This allows the access control information to be accessed quickly and enables the attributes of the data objects in the packed file to be changed. Moreover, an additional column specifying the offset of each data object in the packed file may be generated in the ACT 46 to avoid repeated computation of the offset.

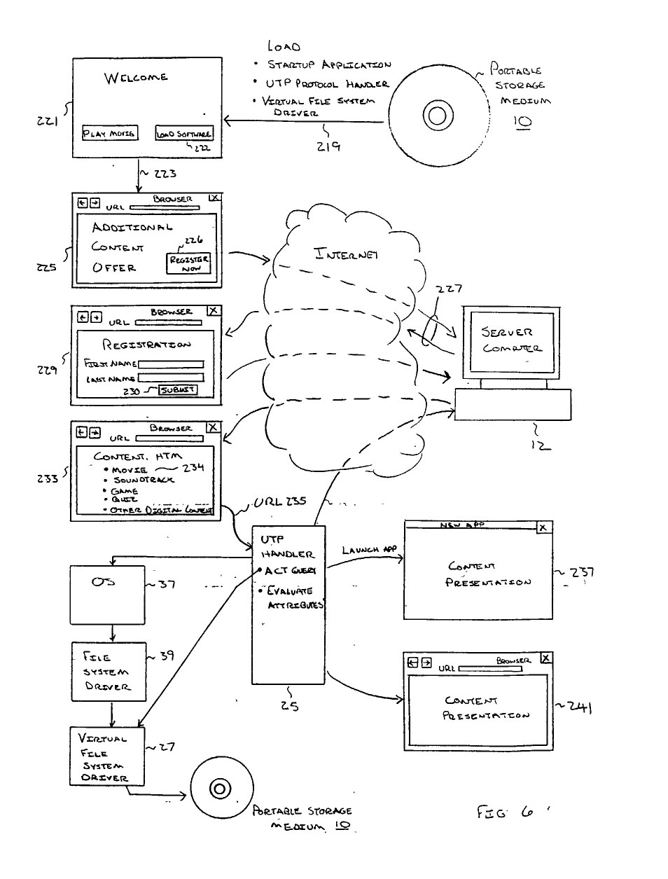

FIG. 6 illustrates an exemplary application of the above described virtual file system driver 27 and UTP handler 25. Initially, a portable storage medium 10 is loaded into a media reader of a user's computer. As discussed above, an installation program resident on the portable storage medium 10 is automatically executed to install a startup application program, the UTP handler 25, and the virtual file system driver 27. This is indicated in FIG. 6 by arrow 219. Note that multiple versions of the UTP handler 25 may be installed, one for each different web browser determined to be present on the user's computer.

After the startup application, UTP handler 25 and virtual file system driver 27 have been installed, the startup application is automatically launched. In one embodiment, the purpose of the startup application is to inform the user that additional content is available from the provider of content on the portable storage medium (i.e., the “content provider”) and to direct the user to the content provider's website. This may be accomplished for example by invoking a web browser on the user's computer with an appropriate URL in the web browser invocation command line. For example, a distributor of movies on DVD may encode different URL's on different DVDs according to the nature of the accompanying movie. In this way, different audiences for different types of movies may be directed to different web pages offering demographically tailored content. Also, the distributor may place additional content in packed files on the DVD, with the content being selected according to the nature of the title movie. For example, a children's movie might include animated shorts, simple games, animation cells that may be printed and used as wallpaper (i.e., computer screen background) and so forth. A more adult feature, on the other hand, might include more sophisticated games, a sound-track for the movie and so forth. Advertisements for products expected to be consumed by the target audience for the movie might also be included in the packed file content. Generally, any information that a content provider might wish to make available to a user of the portable storage medium could be placed in the packed file without departing from the spirit and scope of the present invention.

As shown by way of example in FIG. 6, the startup application causes a “Welcome” display to be presented. The welcome display prompts the user to play a movie (e.g., in the case where a feature movie was included on the portable storage medium) or to load software for accessing additional content. If the user clicks the “load software” button 222, the UTP handler 25 and virtual file system driver 27 are loaded into system memory and a web browsing application is invoked (as indicated by arrow 223). Still referring to FIG. 6, when the web browsing application is initially invoked, a host URL (i.e., content provider URL) is transmitted by the web browser to access a web page 225 from a website specified by the content provider. In this example, the host URL specifies a home page for a website related to a feature film on the portable storage medium. The user is informed that additional content is available to registered members of the site and is prompted to register. If the user clicks the “Register Now” button 226, the URL of a registration page is transmitted to the server computer system 12 used to host the website which, in turn, transmits a registration page 229 that is displayed by the user's web browser. This operation is indicated by arrows 227. In the registration page 229, the user is prompted to enter information which may be a simple set of identification information (e.g., name, electronic mail address, etc.), demographic information such as income, purchasing habits, physical characteristics (age, gender, etc.), entertainment likes and dislikes, and any other information that the content provider may be interested in obtaining. The user may also be prompted to provide money payment for membership and to specify a payment type (e.g., credit card, debit card, account, digital cash, etc.).

After the user has supplied the requested information, the user may click a “Submit” button 230 to cause the information to be transferred to the server computer system 12. The server computer system 12 confirms that the requisite information has been submitted and responds by transferring a web page 233 that provides a list of the content available to the user. The list need not have been generated by the server computer system 12 and may instead have been obtained as a result of the server computer system 12 transmitting a UTP link to the user's computer to cause the UTP handler 25 to execute a library function to generate the list of content based on the readable content found on the portable storage medium 10. In any case, the user is presented with a list of content from which he or she may choose.

Assuming for the sake of illustration that one item of content is an additional movie title 234 offered by the content provider and that the user selects to view the movie. When the user clicks (or otherwise selects) the movie title 234 in the web page 233, a UTP-prefixed URL 235 is passed to the UTP handler 25. In one embodiment, the UTP handler 25 responds to the URL 235 by issuing a FindEntry call to the virtual file system driver 27 to confirm that the URL 235 is present in the ACT and, if so, to obtain the corresponding ACT entry. If the URL 235 is present in the ACT, then the UTP handler 25 evaluates the attributes of the returned ACT entry to determine how to respond. If the IsReadable attribute is not set, then the UTP handler 25 returns an error code to the browser indicating that the data object indicated by the URL was not found. If the IsReadable attribute is set, then the Inline, Volatile and Library attributes are evaluated to determine whether a library function is to be executed, whether to check for newer content on the server computer system 12 (or other server), and whether to launch a new application to present the content embodied in the data object. If the content is to be obtained from the portable storage medium 10, then the UTP handler 25 may access the data object on the portable storage medium via file open and file read calls passed through a chain of software modules, including the operating system 37, file system driver 39 and virtual file system driver 27. The returned data may then be delivered to the web browser for presentation (241). Alternatively, if the Inline attribute is not set, the UTP handler 25 may launch a new application 237 (e.g., a movie player, audio track player or any other application), passing a filename from the URL to the new application as a command line parameter. In that case, the new application will open and read the file via calls to the operating system, resulting in the file system driver and ultimately the virtual file system driver 27 being invoked to access the data object in the packed file that corresponds to the filename.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method of controlling access to a data object stored on a portable storage medium, the method comprising:
receiving a request to access a data object stored on a portable storage medium;
inspecting a first attribute associated with the data object to determine if read access to the data object is permitted;
inspecting an access control portion of a file stored on the portable storage medium to determine an offset within the file at which the data object is stored if the first attribute indicates that read access to the data object is permitted; and
reading the data object at the offset within the file if the first attribute indicates that read access to the data object is permitted.

2. The method of claim 1 wherein the access control portion of the file is encrypted and wherein inspecting an access control portion of a file stored on the portable storage medium comprises decrypting the access control portion of the file.

3. The method of claim 1 wherein receiving a request to access a data object stored on a portable storage medium comprises receiving an address value that specifies a communications protocol for locating the data object, the communications protocol indicating that the data object is stored on the portable storage medium.

4. The method of claim 3 further comprising executing a protocol handling application program and wherein receiving an address value comprises receiving the address value as an input to the protocol handling application program.

5. The method of claim 4 wherein executing the protocol handling application program comprises executing a web browsing application program and wherein receiving the address value comprises receiving a uniform resource locator (URL) as an input to the web browsing application program.

6. The method of claim 5 wherein the URL includes a prefix that specifies a protocol for identifying data objects stored on the portable storage medium.

7. The method of claim 1 further comprising inspecting a second attribute associated with the data object to determine whether an alternate version of the data object is stored externally to the portable storage medium.

8. The method of claim 7 further comprising:
inspecting the alternate version of the data object to determine if the alternate version of the data object is newer than the data object stored on the portable storage medium if the second attribute indicates that the alternate version of the data object is stored externally to the portable storage medium; and
accessing the alternate version of the data object instead of the data object stored on the portable storage medium if the alternate version of the data object is newer than the data object stored on the portable storage medium.

9. The method of claim 7 wherein inspecting the second attribute comprises inspecting the second attribute to determine whether an alternate version of the data object is stored on a server computer that is accessible via a network connection.

10. The method of claim 9 wherein the network connection includes a connection to the server computer via the Internet.

11. The method of claim 1 further comprising receiving from a server computer system a transmission that includes at least one uniform resource locator (URL) which specifies the data object stored on the portable storage medium, and wherein receiving the request to access the data object stored on the portable storage medium comprises receiving user input selecting the at least one URL.

12. The method of claim 11 further comprising providing access to the data object stored on the portable storage medium for a limited period of time by modifying the at least one URL after the limited period of time so that the at least one URL does not specify the data object stored on the portable storage medium.

13. The method of claim 11 further comprising preventing further access to the data object stored on the portable storage medium after a period of time by modifying the first attribute associated with the data object to indicate that read access to the data object is not permitted.

14. The method of claim 1 further comprising executing program code included in the data object if a second attribute associated with the data object is in a first state.

15. The method of claim 14 wherein executing program code included in the data object comprises executing program code to modify an attribute associated with another data object stored on the portable storage medium.

16. The method of claim 14 wherein executing program code included in the data object comprises executing program code to identify data objects stored in the portable storage medium for which read access is permitted.

17. A method of storing a data object on a portable storage medium, the method comprising:
storing the data object at an offset within a file on the portable storage medium;
storing information indicative of the offset in an access control portion of the file; and
encrypting the access control portion of the file to restrict access to the data object.

18. A system for controlling access to a data object stored on a portable storage medium, the system comprising:
a communications network;
a server computer coupled to the communications network; and
a client computer coupled to the communications network, the client computer including a media reader to read a portable storage medium, the client computer being configured to:
receive from the server computer a transmission that includes at least one uniform resource locator (URL);
receive user input selecting the URL, the URL specifying a data object stored on the portable storage medium;
inspect a first attribute associated with the data object to determine if read access to the data object is permitted;
inspect an access control portion of a file stored on the portable storage medium to determine an offset within the file at which the data object is stored if the first attribute indicates that read access to the data object is permitted; and
read the data object at the offset within the file if the first attribute indicates that read access to the data object is permitted.

19. The system of claim 18 wherein the access control portion of the file stored on the portable storage medium is encrypted.

20. An article of manufacture including one or more computer-readable media that embody a program of instructions for controlling access to a data object stored on a portable storage medium, wherein the program of instructions, when executed by a processing unit of a computer, causes the processing unit to:
receive a request to access a data object stored on a portable storage medium;
inspect a first attribute associated with the data object to determine if read access to the data object is permitted;
inspect an access control portion of a file stored on the portable storage medium to determine an offset within the file at which the data object is stored if the first attribute indicates that read access to the data object is permitted; and
read the data object at the offset within the file if the first attribute indicates that read access to the data object is permitted.

21. The article of claim 20 wherein the portable storage medium is one of the one or more computer-readable media included in the article of manufacture.
